(19) United States
(12) Patent Application Publication
(10) Pub. No.: US 2007/0188893 A1
(43) Pub. Date: Aug. 16, 2007

(54) Camera system in particular for an environment detection system of a vehicle

(76) Inventors: Thorsten Cywinski, Freiberg (DE); Thorsten Meyer, Bietigheim-Bissingen (DE); Heiner Bayha, Vaihingen/Enz (DE); Rolf Briem, Asperg (DE); Karl-Heinz John, Wemding (DE); Thomas Stenzenberger, Wemding-Amerbach (DE)

Correspondence Address: DREISS, FUHLENDORF, STEIMLE & BECKER, POSTFACH 10 37 62, D-70032 STUTTGART, DE

(21) Appl. No.: 10/589,565

(22) PCT Filed: Jan. 29, 2005
(86) PCT No.: PCT/EP05/00894

§ 371 Date: Aug. 16, 2006

(30) Foreign Application Priority Data
Feb. 20, 2004 (DE) 10 2004 009 920.0

(51) Int. Cl. G02B 7/02

(52) U.S. Cl. 359/819

(57) ABSTRACT

The invention relates to a camera system, in particular for an environment detection system of a vehicle. The system comprises a retaining frame for retaining a lens carrier, whose lens guides incident light onto an image sensor. The invention is characterized in that the retaining frame comprises a bearing surface for a contact surface of the lens carrier, running essentially parallel to the plane of the image sensor and that the lens carrier can be displaced, in an alignment disposition, on a plane of the bearing surface and can be permanently fixed in a target position. The invention also relates to a system for aligning a lens carrier, comprising a lens, relative to an image sensor.

The invention concerns a camera system, in particular, for an environment detection system of a vehicle, comprising a retaining frame for retaining an optics carrier, whose optics guides incident light onto an image sensor. The invention also concerns a retaining frame for such a camera system and a method for adjusting the optics carrier, comprising the optics, relative to the image sensor.

Vehicles have conventional environment detection system cameras. These environment detection systems detect the surroundings of the vehicle and provide information to further vehicle systems or to the driver. There are e.g. conventional environment detection systems for detecting the rear area of the vehicle using a camera. Other systems provide information when travelling at night (night vision). There are also conventional systems comprising cameras that detect whether or not the driver is within the lane (line detection warning systems).

The conventional camera systems each comprise one object carrier having an optics, in particular one or several lenses. Moreover, an image sensor is provided, e.g. an imager chip or image sensor chip.

When mounting the camera system, one must ensure that the optics carrier comprising the optics assumes a predetermined target position relative to the image sensor in order to assure that the image sensor actually detects the desired image.

It is therefore the underlying purpose of the present invention to provide a camera system that adjusts the optics relative to the image sensor in a simple fashion and fixes it on a permanent basis, which is realized using a minimum number of individual parts. The camera system should be constructed in a simple and space-saving manner.

This object is achieved by a camera system of the above-mentioned type in that the retaining frame comprises a bearing surface for a contact surface of the optics carrier, which extends essentially parallel to the plane of the image sensor, such that the optics carrier can be displaceably fixed in an adjustment position in the plane of the bearing surface, and can be permanently fixed at a target position.

Displacement of the optics carrier is limited to two spatial directions by providing a bearing surface that extends parallel to the image sensor. The optics can only therefore be adjusted parallel to the image sensor. Since the optics carrier can be displaced on the bearing surface of the retaining frame, the optics carrier can be displaced in a simple fashion, either manually or automatically, in the proper direction until the target position has been reached. The optics carrier can be permanently fixed to the retaining frame after reaching the target position.

In a preferred embodiment of the invention, the retaining frame or the optics carrier comprises pretensioning means that are suited to urge the optics carrier against the bearing surface. Such pretensioning means can grasp about and/or behind at least sections of the optics carrier or the retaining frame and are advantageous in that the optics carrier cannot be easily moved in the third spatial direction, i.e. perpendicular to the plane of the image sensor. This ensures that the optics carrier is only moved in the plane of the bearing surface during displacement. By pressing the optics carrier against the bearing surface, the optics carrier moreover cannot automatically move relative to the retaining frame, e.g. due to its intrinsic weight.

The pretensioning means may advantageously be formed as webs, which overlap the bearing or contact surface, which are elastically resilient at least perpendicular to the bearing surface, and which engage behind the optics carrier or the retaining frame in the adjustment and/or target position. Such elastically resilient webs can e.g. be integrally connected to the retaining frame and/or optics carrier or be formed on the retaining frame and/or optics carrier. The optics carrier can be pressed against the retaining frame in response to the elastic resilience.

In a further embodiment of the invention, the retaining frame is formed in such a manner that the optics carrier is permanently connected to the retaining frame in the target position. This permanent connection may be achieved e.g. by gluing or welding the optics carrier to the retaining frame.

In a particularly advantageous fashion, the retaining frame or the optics carrier are produced from a first plastic material, and at least sections of the optics carrier or retaining frame are made from a second optically transparent plastic material, such that the bearing surface can be welded to the contact surface of the retaining frame to produce a permanent connection. Attachment is thereby effected, in particular, through laser welding. The optically transparent plastic material thereby ensures that the two materials melt to each other at their abutting surfaces. The laser radiation can penetrate through the corresponding optically transparent plastic material without damaging it. Welding may be effected, in particular, in the corner regions of the optics carrier.

In a further, preferred embodiment of the invention, the bearing surface or contact surface is delimited, at least in sections, on at least two sides by delimiting webs. Such delimiting webs curtail the displaceability of the optics carrier on the bearing surface of the retaining frame. Any undesired, excessive displacement and any sliding-off of the optics carrier from the retaining frame is thereby counteracted.

Advantageously, the contact surface of the optics carrier may thereby be displaced onto the bearing surface via a side without delimiting web.

In a particularly advantageous embodiment of the invention, the pretensioning means are disposed on the delimiting webs. In this connection, the pretensioning means may be integral with the delimiting webs or may be formed on the delimiting webs.

In accordance with the invention, the bearing surface may be larger than the bearing surface of the optics carrier that is supported on the bearing surface to ensure sufficient displaceability of the optics carrier relative to the retaining frame.

In one compact construction of the camera system, the image sensor and/or retaining frame may be disposed directly on a printed board. The image sensor may be soldered to the strip conductors of the printed board. The retaining frame may e.g. be inserted into retaining recesses or be screwed to the printed board using screws.

The above-mentioned object is also achieved by a corresponding retaining frame or optics carrier and by a method for adjusting an optics carrier, comprising an optics, relative to an image sensor, wherein the retaining frame has a bearing surface which is disposed substantially parallel to the plane of the image sensor. The method is characterized by the following steps:
a) displacement of the contact surface of the optics carrier on the bearing surface of the retaining frame until a target position of the optics or the optics carrier relative to the image sensor or the retaining frame has been obtained; and
b) permanent fixing of the optics carrier to the retaining frame.

In accordance with the invention, a suitable test image may be projected onto the optics to determine the target position, and displacement according to step a) is continued until the position of the test image corresponds to the image of the target position recorded by the image sensor. The test image permits adjustment under suitable conditions. It can be ensured that the optics has assumed the target position relative to the image sensor.

In one embodiment of the invention, permanent fixing is realized through welding and/or gluing of the optics carrier to the retaining frame after the adjustment position has been reached.

Further details and designs of the invention can be extracted from the following description which describes and explains the invention in more detail with reference to the embodiments shown in the drawing.

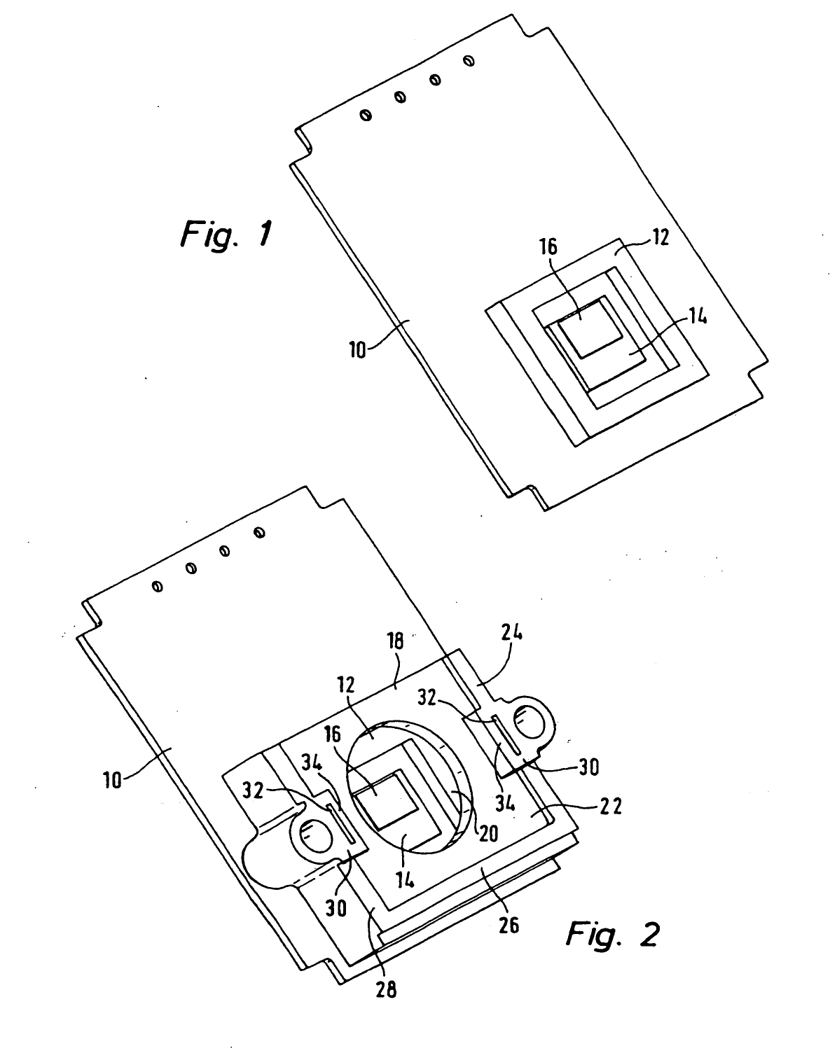

FIGS. 1 through 3 show different mounting steps of a first embodiment of the invention;

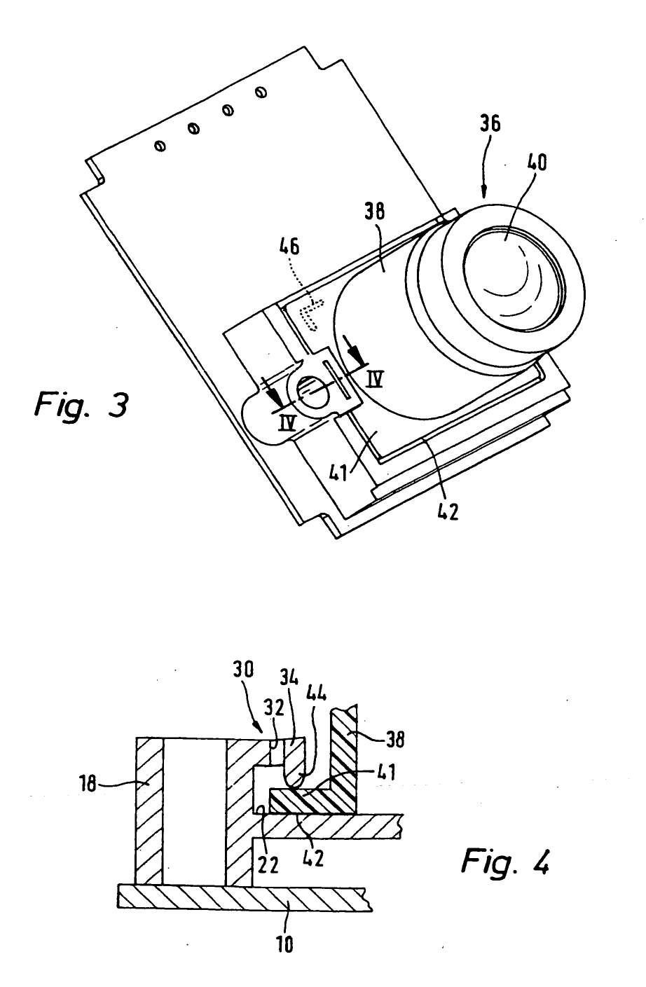

FIG. 4 shows a section along line IV of FIG. 3;

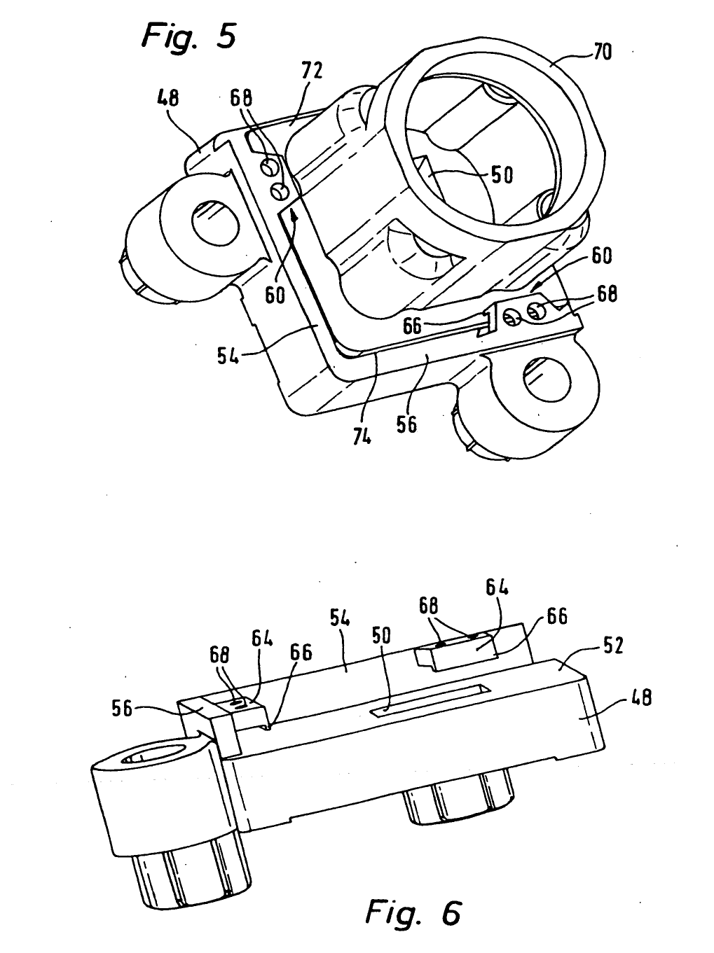

FIG. 5 shows a retaining frame and a lens carrier of a second embodiment of the invention;

FIG. 6 shows a detailed view of the retaining frame according to FIG. 5;

The camera system which is shown in sections in FIGS. 1 through 3 comprises a printed board 10 having an image sensor holder 12 including image sensor 14. The image sensor 14 has a photosensitive surface 16.

A retaining frame 18 is mounted to the image sensor holder 12 including image sensor 14 (FIG. 2). The retaining frame 18 has a central opening 20 through which incident light can reach the photosensitive surface 16. The retaining frame 18 may e.g. be disposed on the printed board 10 using a snap-on connection or by screws.

The retaining frame 18 has a rectangular bearing surface 22 which extends parallel to the plane of the image sensor 14 and parallel to the printed board 10. FIG. 2 clearly shows that the bearing surface 22 is delimited in total on three sides by delimiting webs 24, 26, 28. Pretensioning means 30 are provided in the central regions of both opposing delimiting webs 24, 28. The pretensioning means 30 comprise webs 34 which overlap the bearing surface 22 in the direction of the central opening 20. The webs 34 are moreover elastic to a certain degree, in a direction perpendicular to the bearing surface 22. The pretensioning means 30 have longitudinal slits 32 that provide the elastic resilience. The webs 34 have a separation x from the bearing surface 22.

FIG. 3 shows a lens carrier 36 which has an optics 40 with lenses on its side facing away from the retaining frame 18. The optics 40 is thereby disposed on the free end of a sleeve-like section of the optics carrier 38. The optics carrier has a bearing section 41 on its side facing the retaining frame, with a contact surface 42 which is supported on the bearing surface 22 of the retaining frame 18. The dimensions of the retaining surface 42 are thereby smaller than the dimensions of the bearing surface 22. For this reason, the contact surface 42 of the optics carrier can be displaced on the bearing surface 22 of the retaining frame.

The optics carrier 38 can be pushed below the webs 34 of the pretensioning means 30 via the side of the bearing surface 22 without delimiting webs 24, 26 and 28. The thickness of the contact section 41 is thereby selected to be slightly larger than the separation x between the bearing surface 22 and the webs 34. For this reason, the webs 34 force the contact surface 42 against the bearing surface 22. This ensures safe abutment of the contact surface 42 on the bearing surface 22.

The section through the pretensioning means 30 shows the web 34 and the longitudinal slit 32 (FIG. 4). The figure clearly shows that the web 34 has a nose 44 that faces towards the bearing surface 22 and abuts the contact section 41 of the optics carrier 38.

In order to adjust the optics 40 relative to the image sensor 14, a suitable test image is advantageously projected onto the optics 40. If the position of the image recorded by the image sensor does not correspond to the target position, the optics carrier 38 can be displaced on the bearing surface 22 until the target position has been reached.

When the target position has been reached, the optics carrier 38 is permanently connected to the retaining frame 18. This can be achieved, in particular, through laser welding. Towards this end, the optics carrier 38 is advantageously made from a correspondingly optically permeable material which permits unobstructed penetration of laser radiation. The laser beams are then incident on the bearing surface 22 below the contact section 41 in the region of the contact section, where the material of the retaining frame is melted, thereby welding the optics carrier 38 to the retaining frame 18. Welding may advantageously be spot welding or line welding in the region of the corners of the contact section 41 or bearing surface 22.

FIG. 3 shows an exemplary welding (reference numeral 46).

FIGS. 5 and 6 show a second embodiment of the invention with a retaining frame 48 having a central opening 50. The bearing surface 52 is delimited by two delimiting webs 54, 56 which are disposed perpendicularly to each other. Each of the two delimiting webs 54 and 56 has one pretensioning means 60. The pretensioning means 60 comprise webs 64 (corresponding to FIG. 4) with noses 66 which are directed towards the bearing surface 52.

Recesses in the form of circular holes 68 provide the webs 64 with a certain elastic resilience in a direction perpendicular to the bearing surface 52.

In correspondence with the optics carrier 38, the optics carrier 70 shown in FIG. 5 has a circumferential contact section 72 having a rectangular shape as viewed from the top, whose side facing the bearing surface 52 forms a contact surface 74.

The thickness of the contact section 72 is thereby slightly larger than the separation between the noses 66 and the bearing surface 52. The optics carrier 70 is thereby arranged under pretension on the retaining frame 48.

The optics carrier 70 can be displaced in the plane of the bearing surface 52 to adjust the optics carrier relative to the image sensor (not shown in FIGS. 5 and 6). When the target position has been reached, the optics carrier 70 is advantageously permanently connected to the retaining frame 48 in the region of the contact section 72, in particular through laser welding as described in FIG. 3.

All the features shown in the description, the following claims and the drawing may be essential to the invention either individually or collectively in arbitrary combination.

16. A camera system, suited for an environmental detection system of a vehicle, the system comprising:
an image sensor;
an optics element for guiding incident light to said image sensor;
an optics carrier to which said optics element is mounted, said optics carrier defining a contact surface; and
a retaining frame disposed between and cooperating with said image sensor and said optics carrier, said retaining frame defining a bearing surface extending substantially parallel to a plane of said image sensor, said bearing surface contacting and supporting said contact surface of said optics carrier, wherein, in an adjustment position, said optics carrier is displaceably held in a plane of said bearing surface for subsequent fixing in a target position.

17. The camera system of claim 16, wherein said retaining frame or said optics carrier comprise pretensioning means which are suited to urge said optics carrier against said bearing surface.

18. The camera of claim 17, wherein said pretensioning means comprise elastically resilient members which overlap said bearing surface or said contact surface and which at least partially extend perpendicularly with respect to said bearing surface or said contact surface to engage behind sections of said optics carrier or of said retaining frame.

19. The camera system of claim 17, wherein said pretensioning means have recesses effecting elastic resilience.

20. The camera system of claim 16, wherein said retaining frame is structured to permanently connect said optics carrier to retaining frame in said target position.

21. The camera system of claim 16, wherein said retaining frame or said optics carrier are made from a first plastic material and at least sections of said optics carrier or said retaining frame are made from a second optically transparent plastic material, wherein said bearing surface is subsequently welded to said contact surface of said retaining frame to form a permanent connection.

22. The camera system of claim 17, wherein at least two sides of said bearing surface or said contact surface comprise delimiting elements.

23. The camera system of claim 22, wherein said contact surface of said optics carrier is displaced onto said bearing surface via a side having no delimiting elements.

24. The camera system of claim 22, wherein said pretensioning means are disposed on said at least two delimiting elements.

25. The camera system of claim 16, wherein said bearing surface is larger than said contact surface.

26. The camera system of claim 16, further comprising a circuit board on which said image sensor and/or said retaining frame are disposed.

27. A retaining frame or an optics carrier for the camera system of claim 16.

28. A method for adjusting an optics carrier, bearing an optics element, relative to an image sensor, wherein a retaining frame defines a bearing surface which is substantially parallel to a plane of the image sensor, the optics carrier having a contact surface for abutment against the bearing surface, the method comprising the steps of:
a) displacing the contact surface of the optics carrier on the bearing surface of the retaining frame until a target position of the optics element or of the optics carrier, relative to the image sensor or retaining frame, has been reached; and
b) permanently fixing the optics carrier to the retaining frame.

29. The method of claim 28, wherein a suitable test image is projected onto the optics element to determine the target position, wherein the displacement of step a) is continued until a position of the test image corresponds to an image of the target position recorded by the image sensor.

30. The method of claim 28, wherein permanent fixing is effected through welding and/or gluing.
